(19) United States
(12) Patent Application Publication
(10) Pub. No.: US 2003/0123387 A1
(43) Pub. Date: Jul. 3, 2003

(54) Device and method for filtering network traffic

(76) Inventor: Andrew Lloyd Jackson, Devon (GB)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(21) Appl. No.: 10/029,879

(22) Filed: Dec. 31, 2001

(51) Int. Cl. H04L 12/26

(52) U.S. Cl. 370/230; 370/401

(57) ABSTRACT

A device and method for filtering network traffic is provided utilizing multiple filter tables. A first filter table is maintained in the form of a balanced binary tree that is manipulated by two processors in order to filter traffic between network segments. By initially filtering traffic based upon information contained within the balanced binary tree table, the processing and resource load on the system is significantly reduced. Traffic whose source or destination is not contained within the balanced binary tree table is forwarded to a second processor for filtering based upon a second filter table.

### FIELD OF INVENTION

The present invention relates generally to data communication networks and, more particularly, to receiving and transmitting systems, including Ethernet and other types of communications platforms and including such components as communications processors, protocol processors, network processors, and other devices and peripheral devices.

### BACKGROUND OF THE INVENTION

Modern computer networks typically operate to facilitate the sharing of information or resources across numerous locations. Although various methods exist, one method for transmitting such information operates to break the information into a plurality of equally sized packets each containing address information as well as other identifying information contained within a packet header. The various pieces of information contained within the packet header enable the receiving computer or network device to identify related packets and to re-transmit them or assemble them according to such identification. To further this objective, larger computer networks, such as the Internet, are formed to connect numerous smaller networks, which may be more specialized in their implementation, such as local and wide area networks (LANs and WANs). By connecting the smaller member networks together through backbone elements, users on each of the member networks may share information with each other. Unfortunately, with increases in both the size of the various networks as well as the quantities of data being transmitted and the bandwidth required for such transmission, the act of simply managing and maintaining the connections between the various smaller member networks requires significant processing on the part of the backbone elements. Further, the specific architectures of the individual member networks may also vary from each other, thereby increasing the processing required to pass information between member networks.

In general, each computer network generally includes two or more computers, often referred to as nodes or stations, which are coupled together through selected media and various other network devices for relaying, transmitting, repeating, translating, filtering, etc., the data between the nodes. The term “network device” generally refers to the computers and their network interface cards (NICs) as well as various other devices on the network, such as repeaters, bridges, switches, routers, brouters, etc.

In order to explain and define the various elements which together comprise all computer networks, the International Organization for Standardization (ISO) and the International Telecommunications Union (ITU) developed the Open Systems Interconnection (OSI) reference model in the early 1980's. Essentially, the OSI reference model breaks the various communications (both physical and software) required to transmit information across a network into a series of seven layers or planes: 1) the physical layer; 2) the data-link layer; 3) the network layer; 4) the transport layer; 5) the session layer; 6) the presentation layer; and 7) the application layer. In this manner, network devices operating on the same layer may communicate with each other in an established manner.

Of particular interest to the present application is the data-link layer of the OSI reference model. Network segments consist of groups of nodes that share the same data-link layer and use the same data-link layer protocol.

A bridge is a hardware device that passes packets from one network segment to another. Bridges also operate at the data-link layer of OSI Reference Model and allow several segments to appear as a single segment to higher level protocols or programs. A bridge serves both as a medium (the bridge part) and as a filter by dropping packets that need not be relayed to other segments. In particular, a bridge provides packet filtering functions that reduce the amount of unnecessary packet propagation on each network segment. For example, a two-port bridge allows connectivity between two separate network segments. If the packet source and destination are on the same network segment, propagation to another segment is avoided, thereby increasing availability of the segment to attached stations. A multi-port bridge extends the two-port bridge to support a greater number of segments.

The networking industry generally uses the terms “bridge” and “switch” interchangeably, since, externally, they perform the same or very similar functions. For example, a switch is similar in function to a multi-port bridge. However, a distinction is made based upon whether a packet passes through a common data path between data ports, which is the case for a bridge, or whether the packet passes through independent, concurrent data paths, referred to as a switch fabric or simply “switches”, which is the case for a switch. A bridge interfaces each port to a common processor bus and performs store and forward operations. In particular, a bridge receives a packet from one port via a common bus, determines the destination node or station, and re-transmits the packet to the port associated with the destination node via the common bus. In contrast, a switch interfaces each port to a switch fabric, where each port has an independent data channel to the switch fabric.

Switches and bridges generally collect and store addresses of data packets received for determining the appropriate output port and for performing filtering functions. Each data packet typically includes a source address of the sending station and a destination address for the target station. The source and destination addresses are typically 48-bit media access control (MAC) addresses, which, according to industry standards, are guaranteed to be unique. Storage of MAC addresses and corresponding input/output ports was usually implemented using a content addressable memory (CAM) for each port of the network device. Thus, each port required a dedicated CAM, which limited the number of addresses that could be supported per port. Further, CAMs are relatively expensive. The cost of a plurality of CAMs for supporting multiple ports becomes excessive very quickly.

It is desired to provide a method and apparatus for sorting and tracking MAC or any other type of binary addresses in a networking environment in an efficient manner without excessive cost.

### SUMMARY OF THE INVENTION

The present invention overcomes the problems noted above, and realizes additional advantages, by providing a device and method for filtering network traffic utilizing multiple filter tables. A first filter table is maintained in the form of a balanced binary tree that is manipulated by two processors in order to filter traffic between network segments. By initially filtering traffic based upon information contained within the balanced binary tree table, the processing and resource load on the system is significantly reduced.

The accompanying drawings, which are incorporated in and constitute a part of this specification, illustrate various embodiments of the invention and, together with the description, serve to explain the principles of the invention.

### BRIEF DESCRIPTION OF THE DRAWINGS

FIG. 1 is a block diagram illustrating one embodiment of a packet processing device 100 incorporating the system and method of the present invention;

FIG. 2 is a simplified flow chart illustrating one method of filtering packets received by the system of FIG. 1;

FIG. 3 is a flow chart describing a method for adding an entry to the NP filter table in accordance with one embodiment of the present invention; and

FIG. 4 is a flow chart describing a packet filtering method and system in accordance with one embodiment of the present invention.

### DETAILED DESCRIPTION OF THE PREFERRED EMBODIMENTS

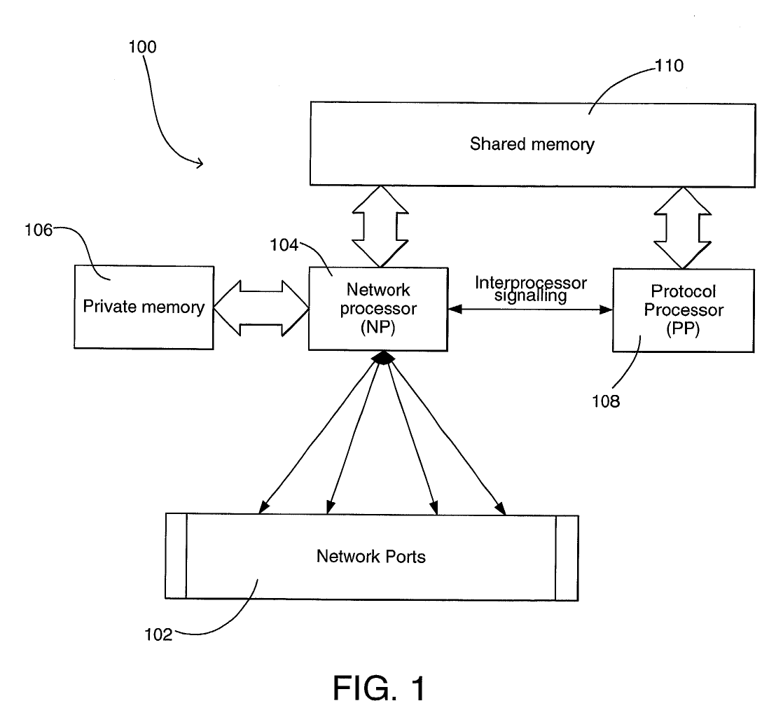

Referring generally to figures and, in particular, to FIG. 1, there is shown a block diagram illustrating one embodiment of a packet processing device 100 incorporating the system and method of the present invention. In particular, packet processing device 100 includes a plurality of network ports 102 for receiving data packets from a variety of network sources. These data packets may be of any suitable form, however, the most common protocol for packets in modern networks such as the Internet is Transmission Control Protocol/Internet Protocol (TCP/IP) packets are preferably utilized, where each TCP/IP packet includes information representative of the following information: version; service type; packet length; time to live; packet protocol employed; the source and destination addresses for the packet; and the actual packet payload information.

The network ports 102 are operationally connected to a network processor 104. The network processor operates at one level to perform the packet receipt and transmission functions of device 100. Network processor 104 is operatively connected to a private memory 106, the use of which will be described in additional detail below. A protocol processor 108 is also operationally connected to the network processor through a shared memory 110. In one embodiment, shared memory 110 may comprise SDRAM (Synchronous Dynamic Random Access Memory). As described above, in conventional dual processor systems, the protocol processor operates to perform all packet filtering and routing functions utilizing the shared memory 110 to store a filter table, as well as data buffers used during the filtering process. Unfortunately, with increasing network size, filtering tables suffer a proportional increase in size and require substantial processing power on the part of the protocol processor to search prior to making forwarding decisions for the various data packets.

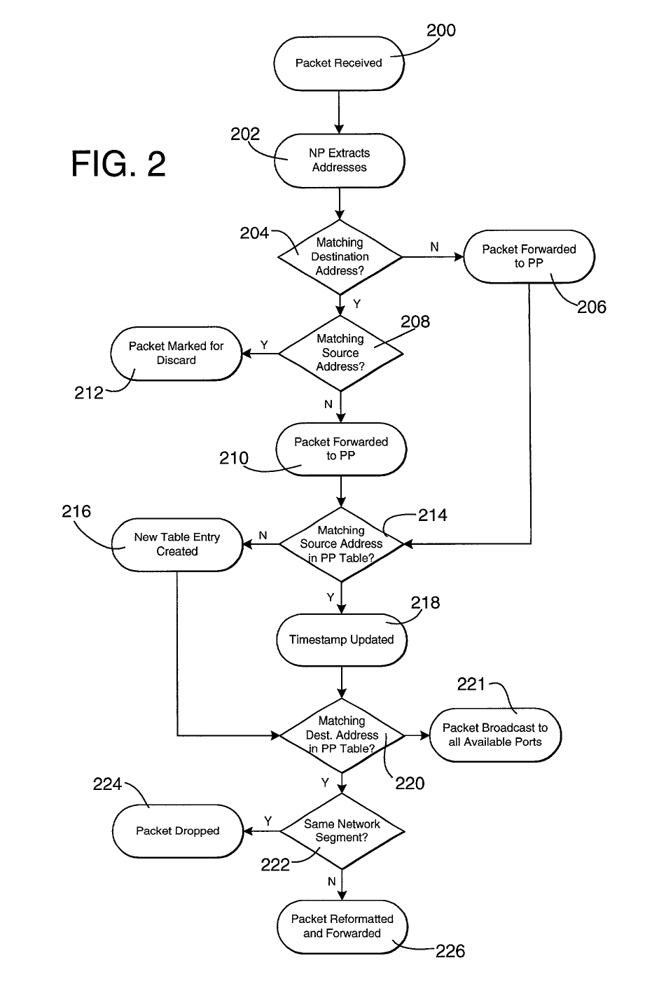

Referring now to FIG. 2, there is shown a simplified flow chart illustrating one method of filtering packets received by the system of FIG. 1. In particular, in step 200, a data packet is received at one of the network ports. In step 202, the network processor extracts the source and destination addresses contained within the packet's header. In a preferred embodiment, these addresses include the media access control (MAC) addresses related to the network devices both sending and eventually receiving the particular packet to be filtered. In step 204, the network processor searches a NP filter table stored in the network processor's private memory and determines whether the extracted destination address is contained within this table. Specific details relating to the format and architecture of the NP filter table and the manner of searching this table will be set forth in additional detail below. If, in step 204, it is determined that the destination address is not found within the NP filter table, then in step 206 the packet is forwarded to the protocol processor via the shared memory for further searching and processing. However, if in step 204 it is determined that the destination address is found within the NP filter table, it is determined in step 208 whether the source address is likewise contained within the NP filter table. If the source address is not found in the table, the packet is passed to the protocol processor for processing in step 210. This stage is necessary so that the NP filter table may be maintained correctly by the protocol processor. However, if in step 208, it is determined that the source address is contained within the NP filter table, the packet is marked for discard in step 212. This allows the protocol processor to determine that traffic has been seen from an end station and allows the filter table to maintained.

Once the network processor has identified packets having either or both the source and destination addresses unknown, the packet filtering task is passed to the protocol processor. In step 214, the protocol processor determines whether the packet's source and destination addresses are contained within a second, PP, filter table stored within the shared memory. The PP filter table preferably includes a complete table including addresses for all of the connected end stations. If it is determined that the source address is unknown, a new filter table entry is created within the PP filter table in step 216. However, if the source address is known, the timestamp of the address is updated within the PP filter table in step 218 to indicate the time at which a packet from that address was last received. In step 220, the protocol processor determines whether the destination address is likewise found within the PP filter table. If not, the packet is broadcast on all available network ports (except the port associated with the source address) in step 221.

In step 222, it is determined whether the identified destination address corresponds to destinations on the same network segment. If so, then the packet is sent to the network port servicing the identified address in step 224. However, if the destination address corresponds to a different network segment, the packet is reformatted and forwarded to this address in step 226. It should be understood that packets are forwarded depending upon the their type. For example, if the destination address of the packet is unknown or if the packet address corresponds to a multicast, or broadcast, address then the packet is sent to all ports connected to the bridge except for the originating port.

Referring now to the particulars of the NP filter table described briefly above, in one preferred embodiment, the NP filter table is held in the form of a balanced binary tree which allows time limited searches to be performed. By enabling such time limited searching, the NP filter table is able to adequately service all active network ports within a bounded time period. In one embodiment, each entry within the NP filter table includes four elements: an address (either destination or source), a port associated with the address, a pair of links (left and right) pointing to other entries (for making forwarding decisions), and a discard count (to be incremented when a packet having the associated address is discarded).

Referring now to particulars of the PP filter table, in a preferred embodiment, the PP filter table maintains a full complement of entries related to all known source and destination addresses. Further, the PP's operation is preferably arranged such that all entries in the full filter table are examined once every second. Since packets are only forward to the PP when not identified in the NP filter table, discard statistics for NP identified packets are read from the NP filter table to the PP filter table. If discards have been made for the entry, the time stamp is updated. The discard statistics are also added to the discard statistics for the identified port.

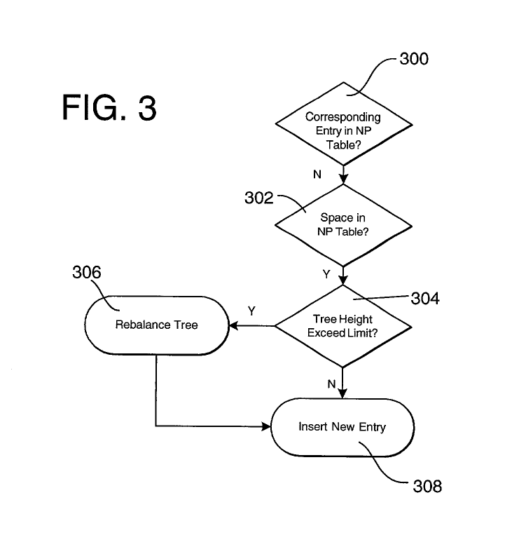

Referring now to FIG. 3, there is shown a flow chart describing a method for adding an entry to the NP filter table in accordance with one embodiment of the present invention. In step 300, the PP determines whether an entry is present in the NP filter table. If not, in step 302, the PP determines whether sufficient space exists in the NP filter table to add the entry and still maintain maximum search times for the table. In step 304, the existing NP filter table binary tree is examined and it is determined whether, upon addition of the new entry, the height of the tree would exceed some predetermined limit. If so, the tree is rebalanced in step 306. Otherwise, rebalancing is not required and the entry is simply inserted into the tree in step 308.

It should be understood that rebalancing of the NP filter table tree does not require that the entire NP filter table be rewritten. Rather, the links within each affected entry are re-written to identify the entries new position in the tree. By deferring the rebalancing of the tree it means that the NP filter tree can be represented as a true, balanced binary tree. This means that the height of the tree is limited to log 2(N), where N is the number of entries in the tree. The tree can also be rebalanced when the height of the tree exceeds log 2(nEntries).

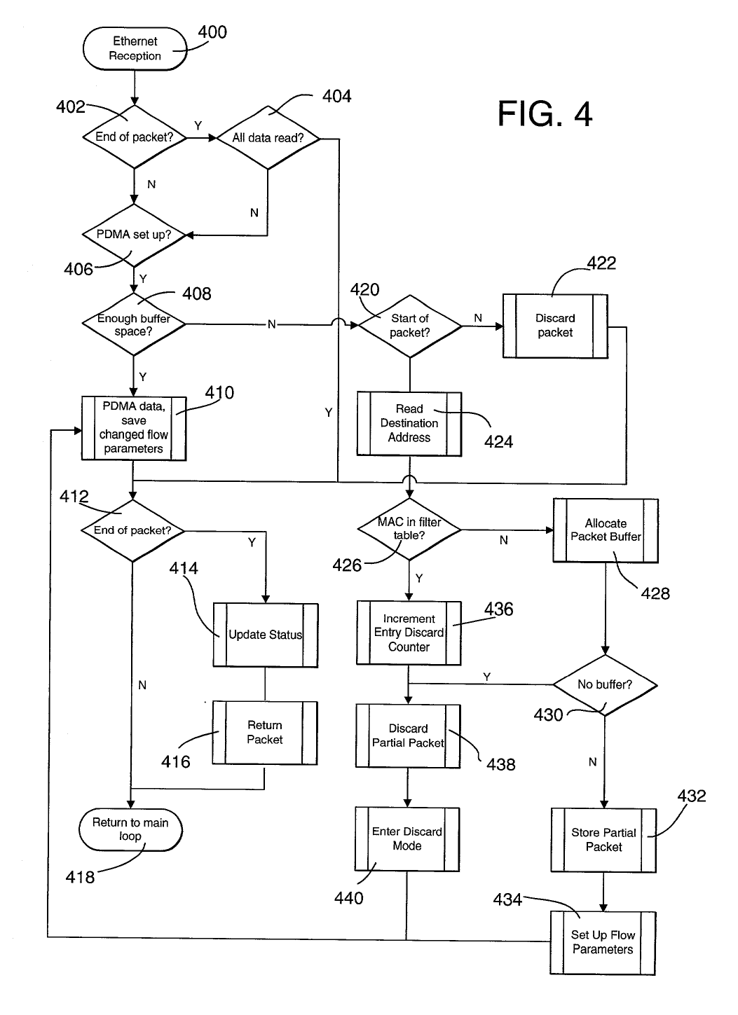

Referring now to FIG. 4, there is shown a flow chart illustrating one preferred method for filtering data packets in accordance with the present invention. In step 400, a data packet is received at one of the network ports. In the described embodiment, the NP receives packets in smaller segments (typically 64 bytes) and continually checks to see if the entire packet has been received. Consequently, in step 402, the network processor determines whether an “end of packet” indication was received indicating that an entire packet has been received and is therefore ready to be filtered. If so, it is determined whether all data has been read from the packet in step 404. If either an “end of packet” indication was not received or all data has not been ready, the system proceeds to step 406, where it is determined whether the system is ready to receive the packet. In one embodiment, this entails determining whether a direct memory access DMA or pseudo DMA (PDMA) has been set up to write the data received at the network ports to the shared system memory. If so, the system determines whether sufficient buffer space (i.e., memory) has been allocated for the received data in step 408.

If buffer space has been allocated to the packet, the system proceeds to step 410 where the (P)DMA data and the associated port control structure (or “flow”) parameters (descriptive of the NP processing state for the current port) are written. Next, in step 412, the system determines again whether the packet reception process is complete by determining if an “end of packet”indication has been received. If so, the system, in step 414, updates the status of the packets passed to the protocol processor by the network processor. The status includes an indication as to whether or not the packet was received correctly and may also include port specific status information. In response to this information, the protocol processor can make the decision as to whether any further processing should take place on the packet. In general, packets received with errors are discarded, however, in some circumstances it is useful to see them. Next, in step 416, the network processor passes the packet and its updated status information to the protocol processor.

If the packet reception process is not complete, or if the packet status has been updated and passed to the protocol processor, the system proceeds to step 418 where the process is returned to the main loop. Essentially, FIG. 4 describes device operation for a single network port. One step above that described in FIG. 4 is a control which identifies the next port to be serviced. Upon identification, packet receiving, transmission and forwarding tasks are performed.

Returning now to step 408, if it is determined that buffer space had not been allocated to the incoming packet, the system proceeds to step 420, where it is determined whether the packet reception process has been initiated by determining if an “start of packet” indication has been received. If not, the system discards the packet in step 422 and proceeds to step 412 described above.

If a “start of packet” indication has been received in step 420, the system proceeds to step 424, where the NP reads the destination address from the packet's header. Next, in step 426, it is determined whether the identified address is contained within the NP filter table. If it is determined that the destination address is not found within the NP filter table, then in step 428 packet buffer space is allocated for the packet. Next, in step 430, it is determined whether buffer space exists. If buffer space does exist, the system proceeds to step 432 where the partial packet is stored during reception. Next, in step 434, the flow parameters for the packet are established. Flow parameters describe, for the current packet buffer, where the data is to be stored, the maximum length of data that may be received, etc. These parameters are set up at the start of packet reception and updated as each 64 byte packet portion is received. The process then proceeds to step 412 described above.

If in step 426, it is determined that the destination address was found within the NP filter table, the system proceeds to step 436, where the filter table entry for the address' discard counter is incremented. In step 438, the system “discards” the partial packet. This may be in response to either step 436 or step 430 described above. Next, the system enters a discard mode in step 440 and proceeds to step 412 described above. One in the discard mode, data is read directly from the network port by the network processor without having to write into the shared memory. This mode improves system performance in a shared processor system because there is less chance of memory contention between the multiple processors, and it is also faster than writing to memory. In a busy system, reduced memory contention means that the protocol processor does not have to block waiting for memory accesses.

The invention uses multiple filter tables, one of which is preferably held in the form of a balanced binary tree that is manipulated by two processors in order to filter traffic when bridging traffic between network segments. It should be understood that the present invention, although described in a multi-processor system, could be equally applied to uniprocessor systems. By providing PP maintenance of the NP's filter table, the NP is able to complete efficient time-bounded searches, where, in the case of a balanced binary tree, the search time is bounded by the height of the binary tree (i.e., O(log n) time, where n is the number of entries in the binary tree). The PP maintains the binary tree, removing time expired entries as required and adding new entries whilst space remains in the table.

While the foregoing description includes many details and specificities, it is to be understood that these have been included for purposes of explanation only, and are not to be interpreted as limitations of the present invention. Many modifications to the embodiments described above can be made without departing from the spirit and scope of the invention, as is intended to be encompassed by the following claims and their legal equivalents.

What is claimed is:

1. A device for filtering traffic in a computer network, comprising:
a first processor for receiving network traffic from at least one network port, wherein the first processor is operatively connected to at least a private memory;
a first filter table resident in the private memory, the first filter table containing at least partial traffic identification information for network traffic received from the at least one network port;
a second processor for network traffic forwarded from the first processor, the second processor being operatively connected to the first processor through at least a shared memory; and
a second filter table maintained in the shared memory, the second filter table containing at least partial traffic identification information for network traffic received from the at least one network port,
wherein the first processor operates to filter network traffic by looking up identification information in the first filter table, when such identification information is not found in the first filter table, the network traffic is forwarded to the second processor.

2. The device of claim 1, wherein the first filter table is in the form of a balanced binary tree.

3. The device of claim 1, wherein the content and format of the first filter table are maintained by the second processor.

4. The device of claim 1, wherein the network traffic identification information comprises at least source and destination addresses.

5. The device of claim 2, wherein the source and destination addresses further comprise media access control addresses unique to particular network devices.

6. A method for filtering traffic in a computer network, comprising the steps of:
receiving, into a first processor, a data packet received at a network port;
extracting packet identification information from the data packet;
determining whether the extracted packet identification information is contained within a first filter table maintained within a private memory operatively connected to the first processor;
forwarding the data packet to a second processor if it is determined that the extracted packet identification information is not contained within the first filter table; and
determining whether the extracted packet identification information is contained within a second filter table maintained within a shared memory operatively connected to both the first processor and the second processor;

7. The method of claim 6, wherein the data packet identification information includes a source address and at least one destination address relating to unique network devices.

8. The method of claim 7, wherein the source and destination addresses are media access control addresses.

9. The method of claim 7, wherein the step of determining whether the extracted packet information is contained within a first filter table further comprises the steps of:
determining whether the first filter table includes the at least one extracted destination address;
forwarding the data packet to the second processor if it is determined that the first filter table does not include the at least one extracted destination address;
determining whether the first filter table includes the extracted source address if it is determined that the first filter table includes the at least one extracted destination address;
forwarding the data packet to the second processor if it is determined that the first filter table does not include the extracted source address;
identifying all network ports associated with the at least one destination address in the first filter table if it is determined that the first filter table includes the extracted source address; and
forwarding the data packet to identified network ports.

10. The method of claim 9, further comprising the step of:
incrementing a discard counter if it is determined that the first filter table includes the extracted source address.

11. The method of claim 7 wherein the step of determining whether the extracted packet information is contained within a second filter table further comprises the steps of:
determining whether the second filter table includes the extracted source address;
creating a new entry in the second filter table if it is determined that the second filter table does not include the extracted source address;
determining whether the second filter table includes the at least one extracted destination address;
forwarding the data packet to all available network ports if it is determined that the second filter table does not include the at least one extracted destination address;
identifying all network ports associated with the at least one destination address if it is determined that the second filter table includes the at least one extracted destination address; and forwarding the data packet to identified network ports.

12. The method of claim 11, further comprising the step of updating a timestamp in the second filter table associated with an extracted source address if it is determined that the second filter table includes the extracted source address.

13. The method of claim 6, wherein the first filter table is in the form of a balanced binary tree.

14. The method of claim 6, wherein the content and format of the first filter table are maintained by the second processor.

15. A method for maintaining the first filter table of claim 2, comprising the steps of:
determining, for a particular entry in the second filter table, whether a corresponding entry exists in the first filter table;
determining whether space exists within the first filter table to add a new entry and maintain maximum search times below a predetermined limit if it is determined that a corresponding entry does not exist;
determining whether, upon addition of a new entry, the height of the binary tree would exceed a predetermined limit if it is determined that space exists within the first filter table;
rebalancing the binary tree if it is determined that, upon addition of a new entry, the height of the binary tree would exceed a predetermined limit; and
inserting a new entry into the tree corresponding the particular entry in the second filter table.
